(19) United States
(12) Patent Application Publication
(10) Pub. No.: US 2014/0155179 A1
(43) Pub. Date: Jun. 5, 2014

(54) METHOD AND APPARATUS FOR GENERATING MAP DATA BASED ON GAME LOG DATA

(71) Applicant: Electronics and Telecommunications Research Institute, Daejeon (KR)

(72) Inventors: Sung June CHANG, Daejeon (KR); Hun Joo Lee, Daejeon (KR)

(73) Assignee: Electronics and Telecommunications Research Institute, Daejeon (KR)

(21) Appl. No.: 13/953,199

(22) Filed: Jul. 29, 2013

(30) Foreign Application Priority Data
Dec. 4, 2012 (KR) 10-2012-0139492

(51) Int. Cl. A63F 13/40

(52) U.S. Cl. CPC A63F 13/10
USPC 463/43

(57) ABSTRACT

Provided is automatic map information configuration based on online game play data. A method of generating map information based on game log data according to the present invention includes extracting behavior data of a character of a user from game log data regarding a game use record of the user; and generating map information as attribute information of at least one zone or point on a game map by analyzing the behavior data.

### CROSS-REFERENCE TO RELATED APPLICATIONS

This application claims priority to and the benefit of Korean Patent Application No. 10-2012-0139492 filed in the Korean Intellectual Property Office on Dec. 4, 2012, the entire contents of which are incorporated herein by reference.

### TECHNICAL FIELD

The present invention relates to automatic map information configuration based on online game play data, and more particularly, to a method and an apparatus for automatically configuring map information using variable game play data.

### BACKGROUND ART

In a method of configuring map information in a program of monitoring a game circumstance, such as an existing game bot, a program of detecting an auto program, and the like, data is manually input data or predefined data is connected to a game. However, the above method has a disadvantage in that all of the game circumstances need to be input in detail or an operation of connecting predefined data needs to be additionally required. Every time a game is updated or a circumstance varies, the updated game or the varied circumstance needs to be newly applied. Although erroneous information is input, there is no means to verify and correct the erroneous information.

### SUMMARY OF THE INVENTION

The present invention has been made in an effort to provide a method and an apparatus that automatically configure map information by analyzing information associated with a map through game data analysis based on a game log, and by extracting the analyzed information, and display the configured map information for a user in real time.

An exemplary embodiment of the present invention provides a method of generating map information based on game log data, the method including: extracting behavior data of a character of a user from game log data regarding a game use record of the user; and generating map information as attribute information of at least one zone or point on a game map by analyzing the behavior data.

The method of generating map information based on game log data further includes comparing and thereby integrating the generated map information with pre-generated existing map information.

The method of generating map information based on game log data further includes displaying, for the user, a map that includes attribute information of at least one zone or point on the map according to the integrated map information.

The integrating may integrate the generated map information and the existing map information using a statistical probability of the behavior data regarding the generated map information and the existing map information.

The generating of the map information may include verifying a behavior attribute of the character by comparing a behavior pattern of the behavior data with a predetermined behavior attribute pattern.

The generating of the map information may generate map information of at least one zone or point on the game map that reflects behavior data regarding the verified behavior attribute.

The generating of the map information may generate map information indicating that at least one zone or point on the game map on which behavior data regarding a hunting behavior occurs is a hunting ground, when the verified behavior attribute information is associated with the hunting behavior of the character.

The generating of the map information may generate map information indicating that at least one zone or point on the game map on which behavior data regarding a transaction behavior occurs is a village, when the verified behavior attribute information is associated with the transaction behavior of the character.

The extracting of the behavior data may extract the behavior data from update log data according to update of a game.

The integrating may compare and thereby integrate the generated map information with the pre-generated existing map information by analyzing the behavior data extracted from the update log data.

Another exemplary embodiment of the present invention provides an apparatus for generating map information based on game log data, the apparatus including: a behavior data extractor configured to extract behavior data of a character of a user from game log data regarding a game use record of the user; and a map information generator configured to generate map information as attribute information of at least one zone or point on a game map by analyzing the behavior data.

According to exemplary embodiments of the present invention, when a difference is present by extracting game data for an attribute associated with a game map based on a game log, analyzing the extracted game data, interpreting information required for map configuration, and verifying consistency between map information and existing map information, map data is integrated using a statistical method. Accordingly, it is possible to generate a system for automatically reflecting a modification on a map in real time based on a game log generated in real time, although a game circumstance varies due to game update and the like.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method of generating map information based on game log data according to an exemplary embodiment of the present invention.

FIG. 2 is a detailed flowchart illustrating a method of generating map information based on game log data according to an exemplary embodiment of the present invention.

FIG. 3 is an exemplary diagram illustrating a system for generating map information based on game log data according to an exemplary embodiment of the present invention.

FIG. 4 is a block diagram illustrating an apparatus for generating map information based on game log data according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description simply exemplifies a principle of the invention. Accordingly, although not clearly described or illustrated in the present specification, those skilled in the art may configure the principle of the invention and may invent a variety of apparatuses included in the concept and scope of the invention. All of the conditional terminologies and exemplary embodiments enumerated in the present specification are clearly intended only for the purpose of understanding the concept of the invention, in principle. Accordingly, the invention should not be understood to be limited to the exemplary embodiments and states particularly enumerated as above.

The aforementioned objects, features, and advantages will become further obvious through the following detailed description which is associated with the accompanying drawings and accordingly, those skilled in the art may easily implement the technical spirit of the invention. When it is determined that the detailed description related to a related known function or configuration may make the purpose of the present invention unnecessarily ambiguous in describing the invention, the detailed description will be omitted herein. Hereinafter, the exemplary embodiments of the present invention will be described in detail with reference to the accompanying drawings.

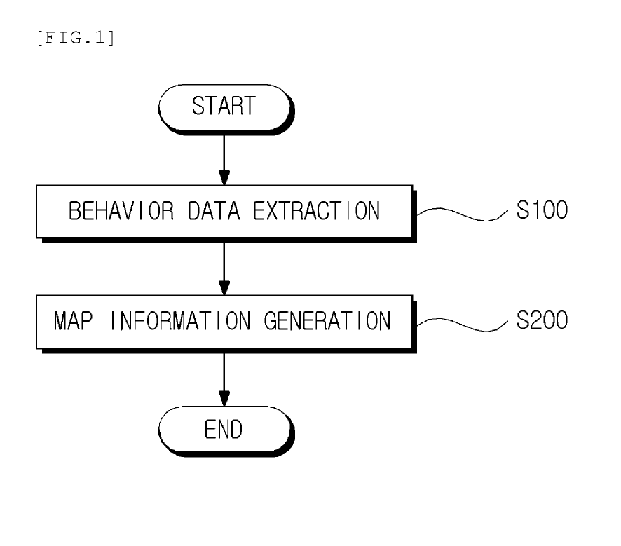

FIG. 1 is a flowchart illustrating a method of generating map information based on game log data according to an exemplary embodiment of the present invention. The method of generating map information based on game log data according to the present exemplary embodiment includes behavior data extraction operation S100 and map information generation operation S200.

The behavior data extraction operation S100 according to the present exemplary embodiment extracts behavior data of a character of a user from game log data regarding a game use record of the user.

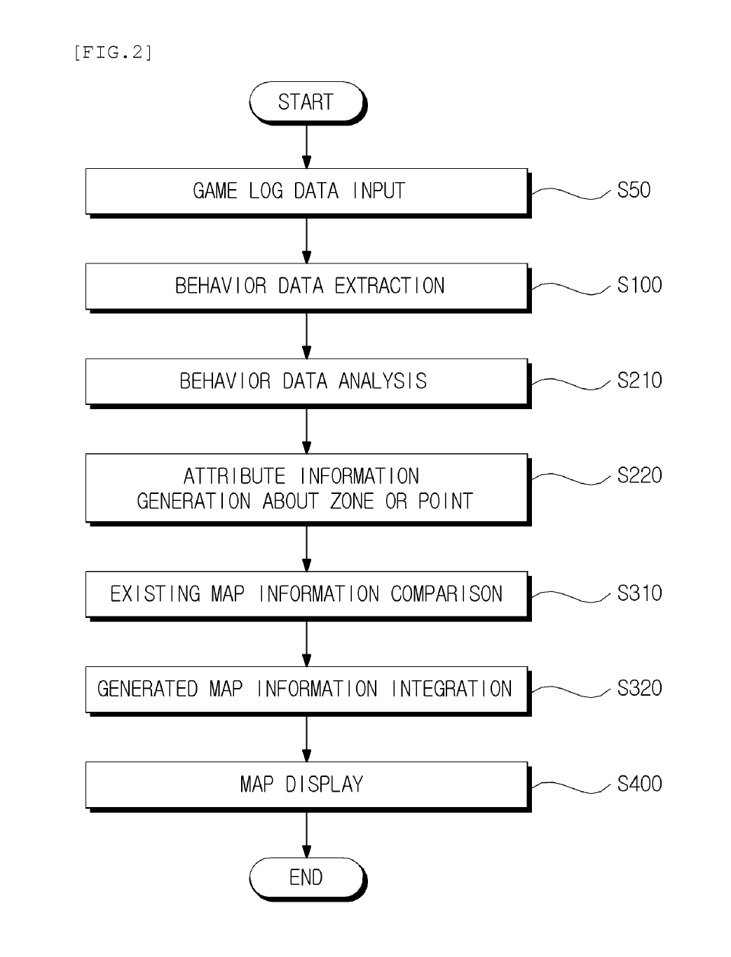

Accordingly, referring to FIG. 2, the method of generating map information according to the present exemplary embodiment may further include operation S50 of receiving game log data. The game log data input operation S50 receives the game log data from an external or an internal memory as source data for extracting behavior data. Update log data according to update of a game may also be received.

In the present exemplary embodiment, a game log refers to use record information of a game when the user proceeds with the game. In the present exemplary embodiment, the game log refers to record information including information about a principle character of an action and additional information when the action occurs while the user is using the game. More specifically, the game log may include data, such as a system log, a character log, and a non-principal character (NPC) log (all of the actions of a character that is not the principal character and excluding the system log), based on a principal character of the action. The game log may include information such as an account name of the user as the principal character, a character name, a class of the character, and a level thereof, and may include information about the reason why the user performs an action as a purpose, information about a time, and position coordinate information on the game in which the action occurs, and information about a target of the action.

The game log may include information about a change in the action in detail. Accordingly, the behavior data extraction operation S100 receives the game log and extracts game data associated with a map. In particular, behavior data generally observed at a predetermined position of the map and the like, such as a hunting or a transaction, is generally extracted.

That is, in the present exemplary embodiment, behavior data may be a behavior log of the character with respect to the position coordinate information of the character on the game, a purpose of the action, or a target of the action among the aforementioned game log data. Hereinafter, map information generation operation S200 of analyzing the extracted behavior data will be described.

The map information generation operation S200 generates map information as attribute information of at least one zone or point on a game map by analyzing the behavior data.

Referring to FIG. 2, the map information generation operation 200 may include behavior data analysis operation S210, and attribute information generation operation S220 about a zone or a point.

The behavior data analysis operation S210 is an operation for verifying an attribute of the extracted behavior data, and for example, may verify a behavior attribute of the character by comparing a behavior pattern of the behavior data with a predetermined behavior attribute pattern.

In the present exemplary embodiment, to verify the behavior attribute may be to verify that an attribute of behavior data is associated with a hunting through the behavior pattern in which the character of the user attacks a character of another user or an NPC. To verify the behavior attribute is to verify that the attribute of behavior data is associated with a transaction through a behavior pattern in which the character of the user sells an item of the user or purchases a new item.

That is, in the present exemplary embodiment, verification of the behavior attribute verifies the behavior attribute of the character by comparing the behavior pattern of behavior data with the predetermined behavior attribute pattern. Accordingly, the predetermined behavior attribute pattern may refer to a pattern in which a movement of the character such as the aforementioned attack is databased for each character in a game production operation.

The attribute information generation operation S220 about the zone or the point generates map information of at least one zone or point on the game map that reflects behavior data regarding the behavior attribute verified in the behavior data analysis operation S210. That is, the map information generated in the present exemplary embodiment may be information that includes the verified behavior attribute and position information of the game map that reflects the behavior attribute.

For example, information associated with a map is converted to information used for the map by analyzing information associated with the map as the behavior attribute, such as determining, as a hunting ground, a region on the map in which a hunting frequently occurs, determining, as a village, a region in which a transaction frequently occurs, and the like. That is, the map information generating operation 5200 generates map information indicating that at least one zone or point on the game map on which behavior data regarding a hunting behavior occurs is a hunting ground, when the verified behavior attribute information is associated with the hunting behavior of the character, and generates map information indicating that at least one zone or point on the game map on which behavior data regarding a transaction behavior occurs is a village, when the verified behavior attribute information is associated with the transaction behavior of the character.

The method of generating map information based on game log data according to the present exemplary embodiment may further include map information integration operation S300 and map display operation S400.

The map information integration operation S300 compares and thereby integrates the generated map information with pre-generated existing map information. Referring to FIG. 2, the map information integration operation S300 includes existing map information comparison operation S310 and generated map information integration operation S320.

The existing map information comparison operation S310 is to determine whether newly analyzed data matches existing data, and to reduce an error of map information. A positional error of map information or an error of attribute information is verified.

The generated map information integration operation S320 generates integrated map information based on the result of the existing map information comparison operation S310. That is, in the present exemplary embodiment, when the generated map information and the existing map information do not match, the generated map information may be integrated using a statistical probability of behavior data regarding the generated map information and the existing map information. For example, it may be possible to select map information calculated through a relatively large number of samples by simply comparing an amount of behavior data used when generating existing map information and an amount of behavior data used when generating current map information. Alternatively, it is possible to select an integration criterion by calculating a probability of existing map information and current map information based on a predetermined algorithm.

When map information is configured by extracting game data using the game log as above, it is possible to automatically configure the map without a need to manually input map information or without using an operation of connecting predetermined map information according to the related art. Although a game is updated or a game circumstance varies, automatically varied map information may be reflected and thus, it is possible to conveniently and accurately configure map information.

The map display operation S400 displays, for the user, a map that includes attribute information of at least one zone or point on the map according to the integrated map information. That is, the map display operation S400 displays the map by synchronizing map attribute information included in map information and position information corresponding thereto with coordinates of the map.

Accordingly, the map displayed according to the present exemplary embodiment may be displayed by partitioning the map and thereby indicating the partitioned map using colors that are classified based on map attribute information, or may also be displayed using texts or intuitive icon information.

The method of generating map information according to the related art refers to a method of manually inputting map information according to update of a game or connecting predefined data with respect to the game, but the method has a disadvantage in that all of the game circumstances need to be input in detail or an operation of connecting predefined data needs to be additionally required. Every time a game is updated or a circumstance varies, the updated game or the varied circumstance needs to be newly applied.

Accordingly, the behavior data extraction operation S100 of the method of generating map information based on game log data according to the present exemplary embodiment may receive update log data according to update of the game, and may also extract behavior data from the update log data.

It is possible to generate new map information by extracting behavior data that varies according to update of the game, and by reflecting the extracted behavior data during a process of integrating the extracted behavior data with existing map information. That is, by comparing and thereby integrating map information, generated by analyzing behavior data extracted from update log data, with pre-generated existing map information, it is possible to generate map information modified according to update. Hereinafter, a system and a server to perform the aforementioned map information generating method will be described.

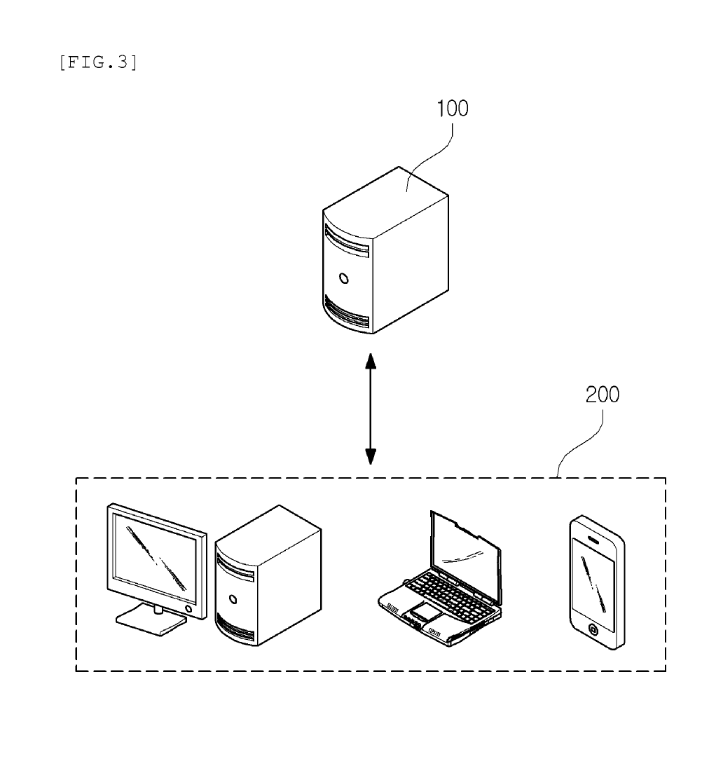

Referring to FIG. 3, a system for generating map information based on game log data according to the present exemplary embodiment includes a user terminal 200 on which a computer game provided from a server 100 is executed and the server 100 configured to provide the computer game, to generate map information, and to provide the generated map information to the user terminal 200.

The server 100 that receives log data regarding a game use record of a user from the user terminal 200 generates map information.

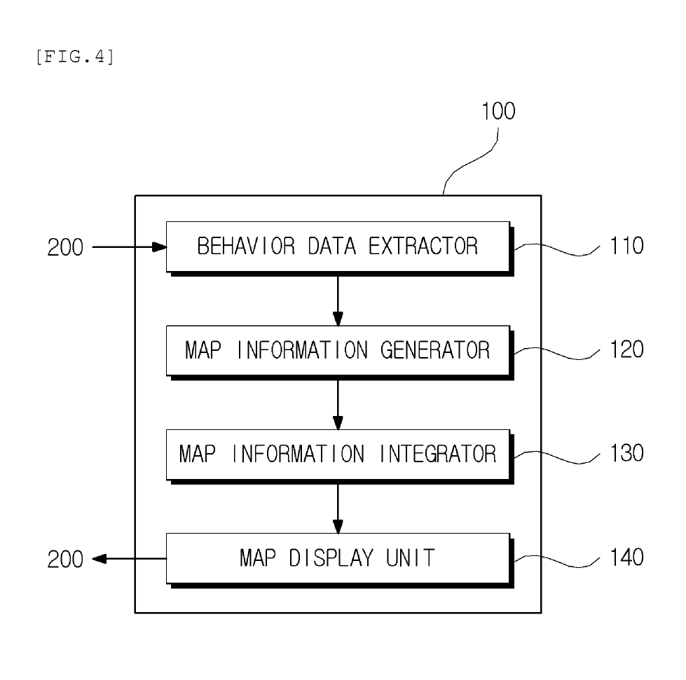

Describing more in detail with reference to FIG. 4, an apparatus for generating map information based on game log data according to the present exemplary embodiment includes a behavior data extractor 110, a map information generator 120, a map information integrator 130, and an a map display unit 140.

The behavior data extractor 110 extracts behavior data of a character of a user from game log data regarding a game use record of the user

The map information generator 120 generates map information as attribute information of at least one zone or point on a game map by analyzing the behavior data.

The map information integrator 130 compares and thereby integrates the generated map information with pre-generated existing map information.

The map display unit 140 displays, for the user, a map that includes attribute information about the at least one zone or point on the map according to the integrated map information

Meanwhile, the method of generating map information based on game log data of the present invention may be configured as a computer-readable code in recording media. Computer-readable recording media include every type of recording apparatuses that store data readable by a computer system.

An example of computer-readable media includes ROM, RAM, CD-ROM, a magnetic tape, floppy disk, an optical data storage apparatus, and the like. The computer-readable media may be distributed over a computer system connected over a network and thus, a computer-readable code using a distribution scheme may be stored therein and thereby be executed. Functional programs, codes, and code segments for embodying the present invention may be easily inferred by programmers in the art.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of generating map information based on game log data, the method comprising:
extracting behavior data of a character of a user from game log data regarding a game use record of the user; and
generating map information as attribute information of at least one zone or point on a game map by analyzing the behavior data.

2. The method of claim 1, further comprising:
comparing and thereby integrating the generated map information with pre-generated existing map information.

3. The method of claim 2, further comprising:
displaying, for the user, a map that includes attribute information of at least one zone or point on the map according to the integrated map information.

4. The method of claim 2, wherein the integrating integrates the generated map information and the existing map information using a statistical probability of the behavior data regarding the generated map information and the existing map information.

5. The method of claim 1, wherein the generating of the map information comprises:
verifying a behavior attribute of the character by comparing a behavior pattern of the behavior data with a predetermined behavior attribute pattern.

6. The method of claim 5, wherein the generating of the map information generates map information of at least one zone or point on the game map that reflects behavior data regarding the verified behavior attribute.

7. The method of claim 6, wherein the generating of the map information generates map information indicating that at least one zone or point on the game map on which behavior data regarding a hunting behavior occurs is a hunting ground, when the verified behavior attribute information is associated with the hunting behavior of the character.

8. The method of claim 6, wherein the generating of the map information generates map information indicating that at least one zone or point on the game map on which behavior data regarding a transaction behavior occurs is a village, when the verified behavior attribute information is associated with the transaction behavior of the character.

9. The method of claim 2, wherein the extracting of the behavior data extracts the behavior data from update log data according to update of a game.

10. The method of claim 9, wherein the integrating compares and thereby integrates the generated map information with the pre-generated existing map information by analyzing the behavior data extracted from the update log data.

11. An apparatus for generating map information based on game log data, the apparatus comprising:
a behavior data extractor configured to extract behavior data of a character of a user from game log data regarding a game use record of the user; and
a map information generator configured to generate map information as attribute information of at least one zone or point on a game map by analyzing the behavior data.

12. The apparatus of claim 11, further comprising:
a map information integrator configured to compare and thereby integrate the generated map information with pre-generated existing map information.

13. The apparatus of claim 12, further comprising:
a map display unit configured to display, for the user, a map that includes attribute information of at least one zone or point on the map according to the integrated map information.

14. The apparatus of claim 12, wherein the map information integrator integrates the generated map information and the existing map information using a statistical probability of the behavior data regarding the generated map information and the existing map information.

15. The apparatus of claim 11, wherein the map information generator comprises:
a behavior verifier configured to verify a behavior attribute of the character by comparing a behavior pattern of the behavior data with a predetermined behavior attribute pattern.

16. The apparatus of claim 15, wherein the map information generator generates map information indicating that at least one zone or point on the game map on which behavior data regarding a hunting behavior occurs is a hunting ground, when the verified behavior attribute information is associated with the hunting behavior of the character.

17. The apparatus of claim 12, wherein the behavior data extractor extracts the behavior data from update log data according to update of a game.

18. The apparatus of claim 17, wherein the map information integrator compares and thereby integrates the generated map information with the pre-generated existing map information by analyzing the behavior data extracted from the update log data.

19. A method of generating map information based on game log data, the method comprising:
extracting behavior data of a character of a user from game log data regarding a game use record of the user;
generating map information as attribute information of at least one zone or point on a game map by analyzing the behavior data;
comparing and thereby integrating the generated map information with pre-generated existing map information; and
displaying, for the user, a map that includes attribute information about the at least one zone or point on the map according to the integrated map information.
